(19) United States
(12) Patent Application Publication
(10) Pub. No.: US 2020/0039132 A1
(43) Pub. Date: Feb. 6, 2020

(54) INJECTION MOLDING DIE, INJECTION MOLDING SYSTEM, AND INJECTION MOLDING METHOD

(71) Applicant: TOYOTA JIDOSHA KABUSHIKI KAISHA, Toyota-shi (JP)

(72) Inventor: Yoichiro Baba, Miyoshi-shi (JP)

(73) Assignee: TOYOTA JIDOSHA KABUSHIKI KAISHA, Toyota-shi (JP)

(21) Appl. No.: 16/434,321

(22) Filed: Jun. 7, 2019

(30) Foreign Application Priority Data
Aug. 6, 2018 (JP) 2018-147818

(51) Int. Cl. B29C 45/26; B29C 45/43; B29C 69/00

(52) U.S. Cl. CPC B29C 45/261; B29L 2022/00; B29C 69/001; B29C 45/43

(57) ABSTRACT

An injection molding die is an injection molding die for molding a resin hollow body including a straight tubular portion having an inner peripheral surface that does not have a tapered portion for die removal. The injection molding die includes a core having a cylindrical portion configured to form the inner peripheral surface of the straight tubular portion. The core has a groove recessed inwardly in the radial direction and formed over a whole circumference of the cylindrical portion in an end portion of the core on a first side in the axial direction, the end portion corresponding to a rear end portion of the resin hollow body in the die-removal direction.

### INCORPORATION BY REFERENCE

The disclosure of Japanese Patent Application No. 2018-147818 filed on Aug. 6, 2018 including the specification, drawings and abstract is incorporated herein by reference in its entirety.

### BACKGROUND

### 1. Technical Field

The disclosure relates to an injection molding die, an injection molding system, and an injection molding method each for molding a resin hollow body including a straight tubular portion having an inner peripheral surface that does not have a tapered portion (a die-removal taper) for die removal.

### 2. Description of Related Art

There has been known an injection molding method for molding a resin hollow body in such a manner that molten resin is filled into a gap (a cavity) between split dies having a recessed portion formed on their contacting faces and a core accommodated in the recessed portion, and after the resin is cooled, the split dies are opened and the resin solidifying around the core is pulled off from the core.

In such an injection molding method, the resin hollow body thus solidifying and contracting sticks to an outer peripheral surface of the core. Accordingly, it is difficult to pull off the resin hollow body from the straight core, and if the resin hollow body is forcibly removed from the straight core, an inner peripheral surface of the resin hollow body might be damaged. Therefore, in an injection molding die used for injection molding, it is common that a tapered shape that facilitates removal of the resin hollow body from the die is formed on the outer peripheral surface of the core such that the core is narrowed toward a die-removal side of the resin hollow body.

In the meantime, a tapered portion (a die-removal taper) formed along the tapered shape is naturally formed on the inner peripheral surface of the resin hollow body molded by the core having the tapered shape. Accordingly, in a case where a container or the like is manufactured by use of such a resin hollow body, there is such a problem that the volume of the container decreases and an amount of contents to be stored therein decreases as compared to a case of using a resin hollow body that does not have a die-removal taper.

In view of this, in order to form a straight resin hollow body that does not have a die-removal taper by injection molding, a technique (e.g., see Japanese Unexamined

Patent Application Publication No. 2012-131136 (JP 2012-131136 A)) in which a hollow body is formed by moving a floating core inside molten resin injected into a cavity, a technique (e.g., see Japanese Unexamined Patent Application Publication No. 2011-131523 (JP 2011-131523 A)) in which a hollow body is pulled off by deforming a core after molding, and other techniques have been proposed.

### SUMMARY

However, the technique in which a resin hollow body is formed by moving a floating core has such a problem that the accuracy of the plate thickness of the resin hollow body is low because it is difficult to control the behavior of the floating core. Further, the technique in which a resin hollow body is pulled off by deforming a core after molding has such a problem that a manufacturing cost increases because a special core is required and the configuration of a molding die is complicated.

The disclosure provides a technology to accurately mold a resin hollow body including a straight tubular portion having an inner peripheral surface that does not have a die-removal taper with a simple configuration while damages caused due to demolding are reduced.

In the disclosure, a protrusion portion projecting inwardly in the radial direction is provided in a rear end portion of a resin hollow body in the die-removal direction, so that a die-removal state similar to a case where a die-removal taper is provided is formed.

More specifically, a first aspect of the disclosure relates to an injection molding die for molding a resin hollow body including a straight tubular portion having an inner peripheral surface that does not have a tapered portion for die removal.

The injection molding die includes a core including a cylindrical portion configured to form the inner peripheral surface of the straight tubular portion. A groove recessed inwardly in the radial direction is formed over a whole circumference of the cylindrical portion in an end portion of the core on a first side in the axial direction, the end portion corresponding to a rear end portion of the resin hollow body in the die-removal direction.

Note that, in the first aspect of the disclosure, the “resin hollow body including a straight tubular portion having an inner peripheral surface that does not have a tapered portion for die removal” indicates a resin hollow body having a zone (a straight tubular portion) in which the axial center of the resin hollow body is parallel with the generating line of the inner peripheral surface of the resin hollow body. The resin hollow body may be a resin hollow body constituted by a straight tubular portion over the whole length or may be a resin hollow body partially including a straight tubular portion.

Further, at the time when the resin hollow body is removed from the core, the resin hollow body is pulled from a base end of the core toward a distal end thereof, that is, the resin hollow body is pulled with a part corresponding to a distal end portion of the core being taken as the front side. In the disclosure, the “end portion of the core on the first side in the axial direction, the end portion corresponding to the rear end portion of the resin hollow body in the die-removal direction” indicates a base end portion of the core.

Based on the above, in this configuration, the groove recessed inwardly in the radial direction is formed over the whole circumference of the base end portion of the core, and therefore, when the molten resin filled in the groove solidifies, a protrusion portion projecting inwardly in the radial direction is formed over the whole circumference of the rear end portion of the resin hollow body in the die-removal direction.

In the meantime, in a case where a die-removal taper is formed in the core to be narrowed toward a die removal side of the resin hollow body, when the resin hollow body is slightly moved forward in the die-removal direction, a gap is formed afterward between the inner peripheral surface of the resin hollow body and the outer peripheral surface of the core.

As described in the first aspect of the disclosure, even in a case where the protrusion portion is formed in the rear end portion of the resin hollow body in the die-removal direction, when the resin hollow body is slightly moved forward in the die-removal direction, the protrusion portion pulled out from the groove runs onto the outer peripheral surface of the core, and the rear end portion of the resin hollow body in the die-removal direction is increased in diameter, so that a gap is formed between the inner peripheral surface of the resin hollow body and the outer peripheral surface of the core.

That is, in the first aspect of the disclosure, with a simple configuration in which the groove is formed in the base end portion of the core, a die-removal state similar to a case where a die-removal taper is provided can be formed without the die-removal taper, and hereby, it is possible to reduce damages to the inner peripheral surface and to pull off the resin hollow body from the core. Besides, since the groove is just formed in the base end portion of the core, there is no risk that the accuracy of the plate thickness of the resin hollow body might decrease.

Thus, with the disclosure, a resin hollow body including an elongated straight tubular portion having an inner peripheral surface that does not have a die-removal taper can be molded accurately with a simple configuration while damages caused due to demolding are reduced.

Further, the injection molding die may further include an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction. The core may include an air passage penetrating through the core in the axial direction.

In this configuration, the cavity is formed between the end surface of the core on the second side (a distal side) in the axial direction and the outer die, so that a part (temporarily referred to as a closing portion) configured to close a front end portion of the resin hollow body in the die-removal direction is formed.

As described above, when the resin hollow body is slightly moved forward in the die-removal direction, the protrusion portion runs onto the outer peripheral surface of the core, so that a gap is formed between the inner peripheral surface of the resin hollow body and the outer peripheral surface of the core. Accordingly, after that, a large force is not required to pull off the resin hollow body from the core. Further, when the resin hollow body is slightly moved forward in the die-removal direction, a gap is also formed between a distal surface of the core and the closing portion, so that the high-pressure air sent into the air passage can be applied to the whole surface of the closing portion. Therefore, by sending the high-pressure air from the air passage, the closing portion is pressed forward in the die-removal direction by the high-pressure air, so that the resin hollow body can be easily removed from the core.

That is, when the protrusion portion is just pulled out from the groove by use of an extrusion device or the like, the resin hollow body can be removed from the core by the high-pressure air afterward, so that the stroke of the extrusion device or the like can be shortened, thereby making it possible to restrain upsizing of the extrusion device or the like. In addition, by sending the high-pressure air, the resin hollow body slightly expands in the radial direction, so that the gap between the inner peripheral surface of the resin hollow body and the outer peripheral surface of the core further expands, so that the resin hollow body can be further more smoothly removed from the core.

A second aspect of the disclosure relates to an injection molding system for molding a resin hollow body including a straight tubular portion having an inner peripheral surface that does not have a tapered portion for die removal.

The injection molding system includes an injection molding die, an extrusion device, and a high-pressure air supply device. The injection molding die includes: a core including a cylindrical portion configured to form the inner peripheral surface of the straight tubular portion, the core having a groove recessed inwardly in the radial direction and formed over a whole circumference of the cylindrical portion in an end portion of the core on a first side in the axial direction, the core including an air passage penetrating through the core in the axial direction, and an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction. The extrusion device is configured to press an end portion of the resin hollow body on the first side in the axial direction toward the second side in the axial direction, the resin hollow body being formed on the outer periphery of the core. The high-pressure air supply device is configured to send high-pressure air into the air passage.

In this configuration, by pressing the resin hollow body toward the second side in the axial direction by the extrusion device, the protrusion portion can be easily pulled out from the groove, and the resin hollow body can be removed from the core by the high-pressure sent by the high-pressure air supply device. Thus, an effect similar to the above effect can be obtained.

Further, a third aspect of the disclosure relates to an injection molding method for molding a resin hollow body including a straight tubular portion having an inner peripheral surface that does not have a tapered portion for die removal.

In the injection molding method, an injection molding die including a core and an outer die is prepared. The core includes a cylindrical portion configured to form the inner peripheral surface of the straight tubular portion. The core has a groove recessed inwardly in the radial direction and formed over a whole circumference of the cylindrical portion in an end portion of the core on a first side in the axial direction. The core includes an air passage penetrating through the core in the axial direction. The outer die is placed such that cavities are formed between the outer die and an end surface of the core on a second side in the axial direction and between the outer die and an outer peripheral surface of the core. The outer die is displaceable to separate from the core toward the second side in the axial direction and toward an outer side in the radial direction.

The injection molding method includes: filling molten resin into the cavities formed between the outer die and the end surface of the core on the second side in the axial direction and between the outer die and the outer peripheral surface of the core; displacing the outer die toward the second side in the axial direction and toward the outer side in the radial direction relative to the core; pressing the resin hollow body toward the second side in the axial direction, such that a protrusion portion formed inside the groove so as to project inwardly in the radial direction runs onto the outer peripheral surface of the core; and sending high-pressure air into the air passage so as to extrude the resin hollow body toward the second side in the axial direction.

With this configuration, an effect similar to the above effect can be obtained.

As described above, with the injection molding die, the injection molding system, and the injection molding method according to the disclosure, a resin hollow body including an elongated straight tubular portion having an inner peripheral surface that does not have a die-removal taper can be molded accurately with a simple configuration while damages caused due to demolding are reduced.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1A is a view schematically illustrating a mold clamping state of an injection molding system according to an embodiment of the disclosure;

FIG. 1B is a view schematically illustrating a mold opening state of the injection molding system according to the embodiment of the disclosure;

FIG. 2 is a view to schematically describe an injection step;

FIG. 3 is an enlarged view corresponding to a part A in FIG. 2;

FIG. 4 is a view to schematically describe a mold opening step;

FIG. 5 is a view to schematically describe a first die removal step;

FIG. 6 is an enlarged view corresponding to a part A in FIG. 5;

FIG. 7 is a view to schematically describe a second die removal step;

FIG. 8A is a view to schematically describe a cutting step;

FIG. 8B is a view to schematically describe the cutting step;

FIG. 9A is a view to schematically describe a mechanism at the time of die removal in a case where a core portion of the present embodiment is used;

FIG. 9B is a view to schematically describe the mechanism at the time of die removal in a case where the core portion of the present embodiment is used;

FIG. 9C is a view to schematically describe a mechanism at the time of die removal in a case where a core portion having a die-removal taper is used;

FIG. 9D is a view to schematically describe a mechanism at the time of die removal in a case where the core portion having the die-removal taper is used;

FIG. 9E is a view to schematically describe a mechanism at the time of die removal in a case where a core portion that does not have a die-removal taper is used;

FIG. 9F is a view to schematically describe a mechanism at the time of die removal in a case where a core portion that does not have a die-removal taper is used;

FIG. 10 is a view schematically illustrating an injection molding die and a resin hollow body according to Modification 1;

FIG. 11 is a view schematically illustrating an injection molding die and a resin hollow body according to Modification 2; and

FIG. 12 is a view schematically illustrating a resin pipe according to Modification 3.

### DETAILED DESCRIPTION OF EMBODIMENTS

With reference to the drawings, the following describes an embodiment to carry out the disclosure.

### Injection Molding System

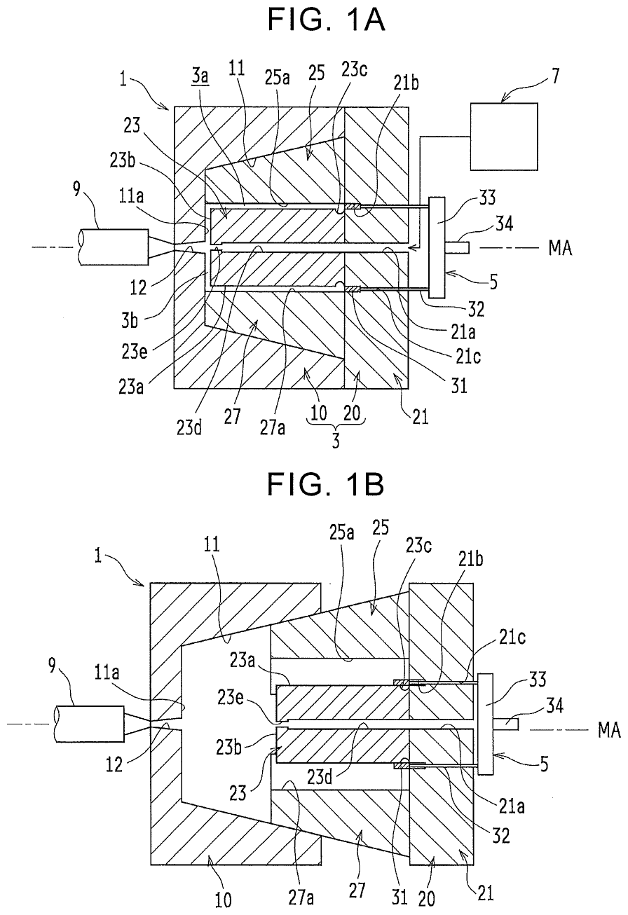

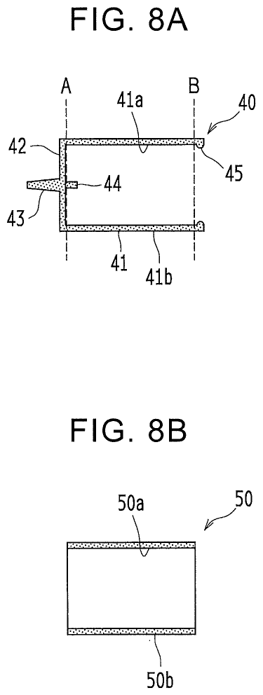

FIGS. 1A and 1B are views schematically illustrating an injection molding system 1 according to the present embodiment. FIG. 1A illustrates a mold clamping state, and FIG. 1B illustrates a mold opening state. The injection molding system 1 is configured to form, by injection molding, an elongated resin hollow body 40 (see FIG. 8A) in which a tapered portion (a die-removal taper) for die removal is not provided on an inner peripheral surface 41a (with a removal angle of 0°). The resin hollow body 40 is an intermediate product for a resin pipe 50 (see FIG. 8B) used for a hydrogen tank and the like. The injection molding system 1 includes an injection molding die 3, an extrusion device 5, and a high-pressure air supply device 7, and has a simple configuration as illustrated in FIG. 1A. Note that the high-pressure air supply device 7 is omitted in FIG. 1B for easy understanding of the figure.

The injection molding die 3 includes a fixed die 10 fixed to a mounting plate of an injection machine (not shown), and a movable die 20 displaceable relative to the fixed die 10 along a die axis MA direction, and the injection molding die 3 is configured to open and close (perform mold opening) in the die axis MA direction.

The fixed die 10 has a recessed portion 11 recessed in the die axis MA direction such that a core portion 23 and outer core portions 25, 27 (described later) are accommodated therein. Further, the fixed die 10 is provided with a resin inlet 12 extending in the die axis MA direction and communicating with the recessed portion 11. An injection nozzle 9 of the injection machine is connected to the resin inlet 12.

The movable die 20 includes a base portion 21, the core portion (a core) 23, and two outer core portions 25, 27.

The base portion 21 includes an air passage 21a extending along the die axis MA in a penetrating manner. Further, the base portion 21 has a toric recessed portion 21b formed around the die axis MA so as to be opened toward the fixed die 10 side. Further, the base portion 21 has a plurality of holes 21c extending in the die axis MA direction and communicating with the recessed portion 21b.

The core portion 23 is configured to form the inner peripheral surface 41a of the resin hollow body 40 and is formed in a right cylindrical shape in which no taper angle is formed on an outer peripheral surface 23a so as to correspond to the resin hollow body 40 that does not have a die-removal taper on the inner peripheral surface 41a. The core portion 23 is fixed to the base portion 21 such that the axial center agrees with the die axis MA. Therefore, the axial direction of the core portion 23 agrees with the die-removal direction of the resin hollow body 40. The outer peripheral surface 23a of the core portion 23 fixed to the base portion 21 is flush with an inner peripheral surface of the toric recessed portion 21b formed in the base portion 21. Note that, in the following description, a base end side (the base portion 21 side) of the core portion 23 is also referred to as a first side in the axial direction, and a distal end side (the fixed die 10 side) of the core portion 23 is also referred to as a second side in the axial direction.

As illustrated in FIGS. 1A, 1B, a groove 23c recessed inwardly in the radial direction is formed over a whole circumference of an end portion (a base end portion) of the core portion 23 on the first side in the axial direction, the end portion corresponding to a rear end portion of the resin hollow body 40 in the die-removal direction. The groove 23c is formed so that its edge is placed in an end of the core portion 23 on the first side in the axial direction. Note that the size of the groove 23c is exaggerated in FIGS. 1A, 1B for easy understanding of the figures.

Further, an air passage 23d penetrating in the axial direction is formed in a central part of the core portion 23. The air passage 23d is formed coaxially with the air passage 21a formed in the base portion 21 and has the same diameter as the air passage 21a. The air passage 23d communicates with the air passage 21a. Further, a reduced portion 23e formed by reducing a part of the air passage 23d in diameter is formed in an end portion (a distal end portion) of the core portion 23 on the second side in the axial direction.

The two outer core portions 25, 27 are configured to form the outer peripheral surface 41b (see FIG. 8A) of the resin hollow body 40. The two outer core portions 25, 27 are connected to the base portion 21 via rails (not shown) so as to be slidable in the up-down direction and are also connected to the fixed die 10 via rails (not shown) so as to be slidable in the inclination direction of the recessed portion 11. Hereby, as illustrated in FIG. 1B, the two outer core portions 25, 27 are configured as split dies that separate from each other in the up-down direction in conjunction with the mold opening of the fixed die 10 and the movable die 20 so as to be released from the outer peripheral surface 41b of the resin hollow body 40. In other words, the two outer core portions 25, 27 are configured to separate outwardly in the radial direction from the core portion 23 in conjunction with the fixed die 10 separating from the core portion 23 to the second side in the axial direction.

Semicylindrical recessed portions are respectively formed on contacting faces (sectioned surfaces) of the two outer core portions 25, 27, so that a right cylindrical space coaxial with the core portion 23 and having an inside diameter larger than the outside diameter of the core portion 23 is formed in a mold clamping state. Hereby, a first cavity 3a having a cylindrical shape is formed between inner peripheral surfaces 25a, 27a of the outer core portions 25, 27, sectioning the recessed portion, and the outer peripheral surface 23a of the core portion 23. Note that, in the mold clamping state, the inner peripheral surfaces 25a, 27a of the outer core portions 25, 27 are flush with an outer peripheral surface of the toric recessed portion 21b formed in the base portion 21.

Further, as illustrated in FIGS. 1A, 1B, in the injection molding die 3 of the present embodiment, a second cavity 3b having a discal shape is formed between a bottom face 11a of the recessed portion 11 of the fixed die 10 and an end surface 23b of the core portion 23 on the second side in the axial direction. The second cavity 3b communicates with the resin inlet 12.

Hereby, in the present embodiment, the fixed die 10 and the two outer core portions 25, 27 correspond to “an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction” in the disclosure.

The extrusion device 5 includes a mechanical ejector (not shown), an ejector ring 31, a plurality of rods 32, an ejector plate 33, and an ejector pin 34.

The ejector ring 31 is accommodated in the toric recessed portion 21b formed in the base portion 21 such that a distal surface of the ejector ring 31 is flush with a surface of the base portion 21 to which the core portion 23 is attached. As mentioned above, the outer peripheral surface 23a of the core portion 23 is flush with the inner peripheral surface of the recessed portion 21b, and the inner peripheral surfaces 25a, 27a of the outer core portions 25, 27 are flush with the outer peripheral surface of the recessed portion 21b, so that the ejector ring 31 accommodated in the recessed portion 21b sections an end surface of the first cavity 3a on the first side in the axial direction.

Note that, for easy understanding of the figures, FIGS. 1A, 1B illustrate the thickness of the ejector ring 31 in the die axis MA direction in an exaggerated manner, but in practice, the thickness of the ejector ring 31 is set to an extremely small value with respect to the whole length of the core portion 23.

The rods 32 are slidably passed through the holes 21c formed in the base portion 21, respectively. Distal end portions (end portions on the second side in the axial direction) of the rods 32 are connected to the ejector ring 31, and base end portions (end portions on the first side in the axial direction) thereof are fixed to the ejector plate 33. The ejector plate 33 is connected to the ejector pin 34 provided in the mechanical ejector.

The ejector pin 34 is configured to advance and retreat in the die axis MA direction by the mechanical ejector, and hereby, the ejector plate 33 and the rods 32 advance and retreat in the die axis MA direction. In conjunction with the advance and retreat of them, the ejector ring 31 is accommodated in the recessed portion 21b as illustrated in FIG. 1A and is extruded from the recessed portion 21b as illustrated in FIG. 1B.

As illustrated in FIG. 1A, the high-pressure air supply device 7 is connected to the air passage 21a formed in the base portion 21 and is configured to send high-pressure air into the air passage 21a and the air passage 23d in communication with this.

### Injection Molding Method

Next will be described an injection molding method using the injection molding system 1. The injection molding method of the present embodiment includes an injection step, a mold opening step, a first die removal step, a second die removal step, and a cutting step.

### Injection Step

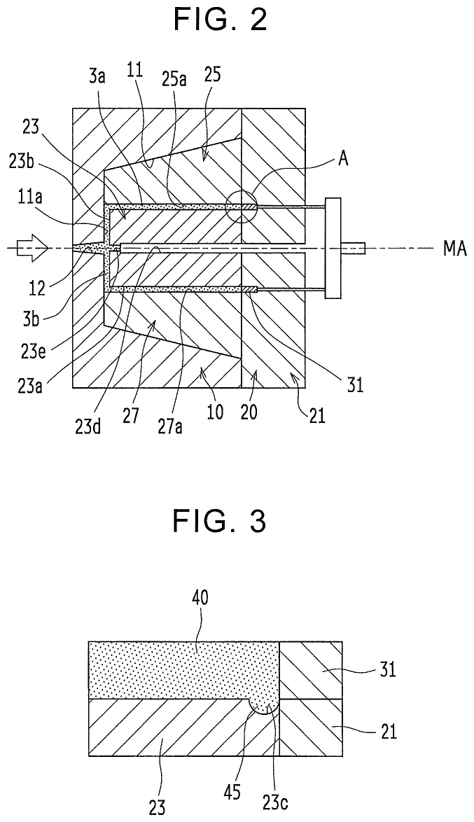

FIG. 2 is a view to schematically describe the injection step. In the injection step, molten resin is filled into the first cavity 3a formed between the outer peripheral surface 23a of the core portion 23 and the inner peripheral surfaces 25a, 27a of the outer core portions 25, 27 and the second cavity 3b formed between the end surface 23b of the core portion 23 on the second side in the axial direction and the bottom face 11a of the recessed portion 11 of the fixed die 10.

More specifically, as illustrated in FIG. 2, in a state (mold clamping state) where the fixed die 10 and the movable die 20 are closed, the molten resin is injected from the injection machine into the resin inlet 12 via an injection nozzle 9 as indicated by a blank arrow in FIG. 2. The molten resin thus injected reaches the second cavity 3b through the resin inlet 12. The molten resin thus reaching the second cavity 3b radially spreads from a central part (a position corresponding to the resin inlet 12) inside the second cavity 3b and reaches an outer end portion (the inner peripheral surfaces 25a, 27a of the outer core portions 25, 27) of the second cavity 3b in the radial direction, and after that, the molten resin is supplied to the first cavity 3a. After the molten resin is filled into the first cavity 3a and the second cavity 3b, the injection step is completed.

As such, in the present embodiment, by providing the second cavity 3b in addition to the first cavity 3a, the molten resin can be supplied to the cylindrical first cavity 3a uniformly over 360°. Accordingly, as compared to a case where the molten resin is supplied to the first cavity 3a from one place, for example, the molten resin can be filled evenly into the first cavity 3a.

Note that the molten resin supplied to the second cavity 3b also enters the air passage 23d. However, the reduced portion 23e is formed in a distal end portion (an end portion on the second side in the axial direction) of the air passage 23d, so only a small amount of the molten resin enters the air passage 23d, and the small amount of the molten resin thus entering is cooled to solidify and stops around the reduced portion 23e.

FIG. 3 is an enlarged view corresponding to a part A in FIG. 2. When the molten resin supplied to the first cavity 3a via the second cavity 3b reaches an end portion of the first cavity 3a on the first side in the axial direction, the molten resin is also filled into the groove 23c formed in the end portion of the core portion 23 on the first side in the axial direction, as illustrated in FIG. 3. When the molten resin filled in the groove 23c is cooled to solidify, a protrusion portion 45 projecting inwardly in the radial direction is formed over a whole circumference of an end portion of the resin hollow body 40 on the first side in the axial direction as illustrated in FIG. 3.

### Mold Opening Step

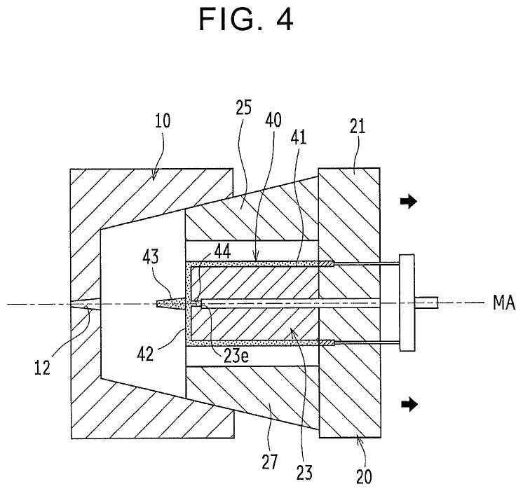

FIG. 4 is a view to schematically describe the mold opening step. The mold opening step is performed after the filled molten resin is cooled to solidify, a cylindrical portion 41 is formed in the first cavity 3a, and a discal closing portion 42 is formed in the second cavity 3b. In the mold opening step, the fixed die 10 is displaced to the second side in the axial direction relative to the core portion 23, and the outer core portions 25, 27 are displaced outwardly in the radial direction relative to the core portion 23.

More specifically, the movable die 20 is pulled in the die axis MA direction so as to separate from the fixed die 10 as indicated by a black arrow in FIG. 4. Then, the two outer core portions 25, 27 slidably connected to the base portion 21 and the fixed die 10 via rails separate from each other in the up-down direction (the radial direction of the resin hollow body 40) in conjunction with the mold opening of the fixed die 10 and the movable die 20. Hereby, the fixed die 10 is released from the closing portion 42 toward the second side in the axial direction, and the two outer core portions 25, 27 are released outwardly in the radial direction from the cylindrical portion 41, so that the mold opening step is completed.

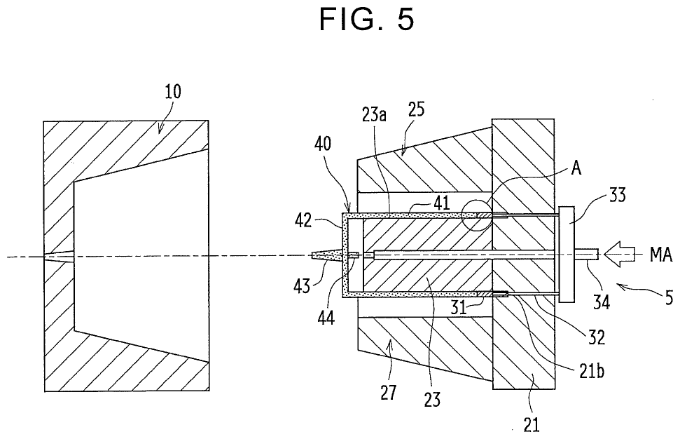

Note that the two outer core portions 25, 27 are opened to a position where the outer core portions 25, 27 leave the fixed die 10 (see FIG. 5). Further, a reference sign 43 in FIG. 4 is a spool formed when the molten resin is cooled to solidify in the resin inlet 12, and a reference sign 44 is a spool formed when the molten resin is cooled to solidify in the reduced portion 23e.

### First Die Removal Step

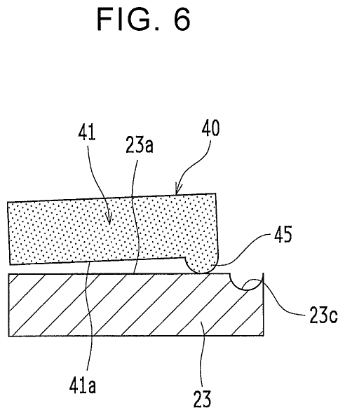

FIG. 5 is a view to schematically describe the first die removal step, and FIG. 6 is an enlarged view corresponding to a part A in FIG. 5. In the first die removal step, the resin hollow body 40 remaining in the core portion 23 is pressed toward the second side in the axial direction, so that the protrusion portion 45 formed inside the groove 23c so as to project inwardly in the radial direction runs onto the outer peripheral surface 23a of the core portion 23.

More specifically, as indicated by a blank arrow in FIG. 5, the ejector pin 34 of the mechanical ejector is moved in the die axis MA direction, so as to press the ejector plate 33 toward the base portion 21 side by a small amount (e.g., just by the thickness of the ejector ring 31 in the die axis MA direction). Hereby, the rods 32 fixed to the ejector plate 33 are pressed, so that the ejector ring 31 connected to the rods 32 is pushed out by the recessed portion 21b.

As mentioned above, the ejector ring 31 sections the end surface of the first cavity 3a on the first side in the axial direction, and therefore, when the ejector ring 31 is pushed out by the recessed portion 21b, the resin hollow body 40 is pressed toward the second side in the axial direction, as illustrated in FIG. 5. When the resin hollow body 40 is pressed toward the second side in the axial direction, the protrusion portion 45 is pulled out from the groove 23c formed in the core portion 23 so as to run onto the outer peripheral surface 23a of the core portion 23 as illustrated in FIG. 6, and hereby, the first die removal step is completed.

Here, the protrusion portion 45 is formed in an end portion of the cylindrical portion 41 on the first side in the axial direction, in other words, at a position, in the resin hollow body 40, where a force from the ejector ring 31 is most easily applied. Accordingly, the protrusion portion 45 can be easily pulled out from the groove 23c.

Further, the protrusion portion 45 is formed in the end portion of the cylindrical portion 41 on the first side in the axial direction, the end portion being most easily deformable. Accordingly, when the protrusion portion 45 runs onto the outer peripheral surface 23a of the core portion 23, the end portion of the cylindrical portion 41 on the first side in the axial direction can be easily increased in diameter as illustrated in FIG. 6. When the end portion of the cylindrical portion 41 on the first side in the axial direction, that is, the rear end portion of the resin hollow body 40 in the die-removal direction is increased in diameter as such, a gap is formed between the inner peripheral surface 41a of the resin hollow body 40 and the outer peripheral surface 23a of the core portion 23 over the whole length of the resin hollow body 40.

Accordingly, in the present embodiment, the extrusion device 5 including the mechanical ejector, the ejector ring 31, the rods 32, the ejector plate 33, and the ejector pin 34 corresponds to “an extrusion device configured to press an end portion of the resin hollow body on the first side in the axial direction toward the second side in the axial direction, the resin hollow body being formed on an outer periphery of the core” in the disclosure.

Note that, in order to effectively increase the diameter of the cylindrical portion 41, it is preferable that the height of the protrusion portion 45 be several percent to dozens of percent to the plate thickness of the cylindrical portion 41, and therefore, it is preferable that the depth of the groove 23c formed in the core portion 23 be several percent to dozens of percent to the plate thickness of the cylindrical portion 41.

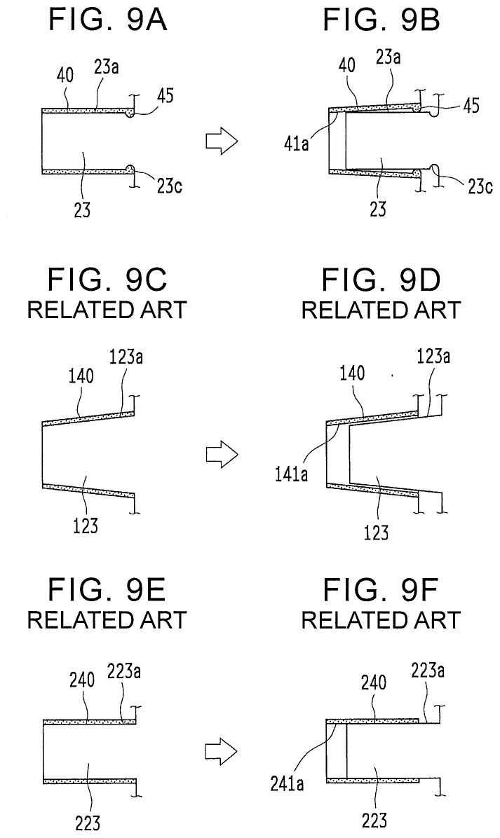

FIGS. 9A to 9F are views to schematically describe a mechanism at the time of die removal. FIGS. 9A, 9B illustrate a case where the core portion 23 of the present embodiment is used, FIGS. 9C, 9D illustrate a case where a core portion 123 having a die-removal taper is used, and FIGS. 9E, 9F illustrate a case where a core portion 223 just without a die-removal taper is used. In a case where injection molding is performed, in the core portions 23, 123, 223, resin hollow bodies 40, 140, 240 contracting by cooling stick to respective outer peripheral surfaces 23a, 123a, 223a of the core portions 23, 123, 223, as illustrated in FIGS. 9A, 9C, 9E.

In the case of the core portion 223 just without a die-removal taper, an inner peripheral surface 241a of the resin hollow body 240 consistently makes contact with the outer peripheral surface 223a of the core portion 223 from the start of die removal to the end of die removal, as illustrated in FIG. 9F. On this account, it is difficult to pull off the resin hollow body 240 from the straight core portion 223, and when the resin hollow body 240 is pulled off forcibly, the inner peripheral surface 241a of the resin hollow body 240 might be damaged.

On the other hand, in the case of the core portion 123 having a die-removal taper, when the resin hollow body 140 is slightly moved forward in the die-removal direction at the time of the start of die removal, a gap is formed afterward between an inner peripheral surface 141a of the resin hollow body 140 and the outer peripheral surface 123a of the core portion 123, as illustrated in FIG. 9D. Accordingly, the resin hollow body 140 can be pulled off from the core portion 123 smoothly without damaging the inner peripheral surface 141a of the resin hollow body 140.

In the case of the core portion 23 of the present embodiment, when the resin hollow body 40 is slightly moved forward in the die-removal direction at the time of the start of die removal, the protrusion portion 45 runs onto the outer peripheral surface 23a of the core portion 23, and the rear end portion of the resin hollow body 40 in the die-removal direction is increased in diameter, so that a gap is formed between the inner peripheral surface 41a of the resin hollow body 40 and the outer peripheral surface 23a of the core portion 23 over the whole length of the resin hollow body 40, as illustrated in FIG. 9B.

That is, in the present embodiment, with a simple configuration in which the groove 23c is formed in the base end portion of the core portion 23, a die-removal state similar to a case where a die-removal taper is provided can be formed without the die-removal taper, and hereby, it is possible to reduce damages to the inner peripheral surface 41a and pull off the resin hollow body 40 from the core portion 23.

### Second Die Removal Step

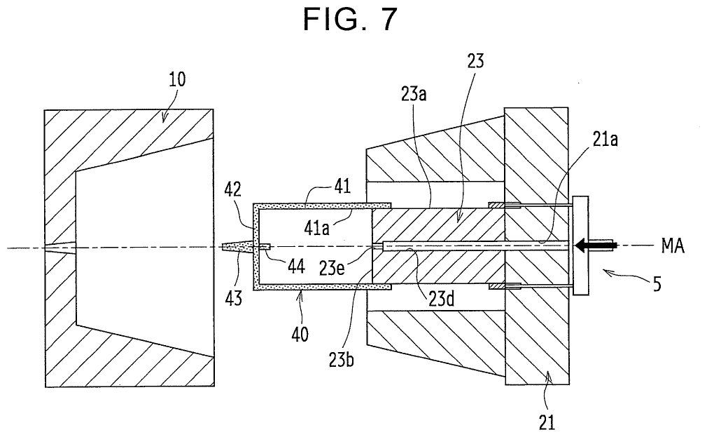

FIG. 7 is a view to schematically describe the second die removal step. In the second die removal step, the high-pressure air is sent into the air passage 23d, so that the resin hollow body 40 is extruded toward the second side in the axial direction. More specifically, as indicated by a black arrow of FIG. 7, by sending the high-pressure air into the air passage 21a formed in the base portion 21 from the high-pressure air supply device 7, the high-pressure air is sent into the air passage 23d communicating with the air passage 21a.

As mentioned above, when the resin hollow body 40 is slightly moved forward in the die-removal direction, the protrusion portion 45 runs onto the outer peripheral surface 23a of the core portion 23, so that a gap is formed between the inner peripheral surface 41a of the resin hollow body 40 and the outer peripheral surface 23a of the core portion 23. Accordingly, after that, a large force is not required to pull off the resin hollow body 40 from the core portion 23. Further, in a state where the end surface 23b of the core portion 23 on the second side in the axial direction makes tight contact with the closing portion 42, the high-pressure air is applied just by an amount corresponding to the area of the reduced portion 23e. However, when the resin hollow body 40 is slightly moved forward in the die-removal direction in the first die removal step, a gap is also formed between the end surface 23b of the core portion 23 on the second side in the axial direction and the closing portion 42. Accordingly, the high-pressure air from the air passage 23d can be applied to the whole surface of the closing portion 42. Therefore, by sending the high-pressure air from the air passage 23d, the closing portion 42 is pressed forward in the die-removal direction by the high-pressure air, so that the resin hollow body 40 can be easily removed from the core portion 23.

That is, when the protrusion portion 45 is just pulled out from the groove 23c by use of the extrusion device 5 in the first die removal step, the resin hollow body 40 can be removed from the core portion 23 by the high-pressure air afterward. Accordingly, the stroke of the extrusion device 5 can be shortened, thereby making it possible to restrain upsizing of the extrusion device 5. In addition, the cylindrical portion 41 slightly expands in the radial direction by sending the high-pressure air, so that the gap between the inner peripheral surface 41a of the resin hollow body 40 and the outer peripheral surface 23a of the core portion 23 further expands. Hereby, the resin hollow body 40 can be more smoothly removed from the core portion 23.

### Cutting Step

FIGS. 8A, 8B are views to schematically describe a cutting step. In the cutting step, in order to cut the spools 43, 44, the closing portion 42, and the protrusion portion 45 that are needless after completion of demolding, the resin hollow body 40 is cut at positions of a broken line A and a broken line B in FIG. 8A. Hereby, as illustrated in FIG. 8B, the elongated resin pipe 50 that is a straight pipe in which an outer peripheral surface 50b is straight and an inner peripheral surface 50a does not have a die-removal taper can be molded.

### Effects

As described above, in the present embodiment, with a simple configuration in which the groove 23c is formed in the base end portion of the core portion 23, a die removal state similar to a case where a die-removal taper is provided can be formed even without the die-removal taper, and this makes it possible to reduce damages to the inner peripheral surface 41a and to pull off the resin hollow body 40 from the core portion 23. Besides, since the groove 23c is just formed in the base end portion of the core portion 23, there is no risk that the accuracy of the plate thickness of the resin hollow body 40 might decrease. Accordingly, the elongated resin hollow body 40 having the inner peripheral surface 41a that does not have a die-removal taper can be molded accurately with a simple configuration while damages caused due to demolding are reduced.

Further, by providing the groove 23c for forming the protrusion portion 45 in the base end portion of the core portion 23, it is possible to shorten the cut length of the cylindrical portion 41 to be cut in the cutting step, thereby making it possible to restrain a decrease in yield.

Further, by providing the second cavity 3b, it is possible to evenly fill the molten resin into the first cavity 3a.

Further, since the protrusion portion 45 is formed at the position, in the resin hollow body 40, where a force from the ejector ring 31 is most easily applied, the protrusion portion 45 can be easily pulled out from the groove 23c.

Further, by using extrusion by the extrusion device 5 and pull-out by the high-pressure air, it is possible to shorten the stroke of the extrusion device 5, thereby making it possible to restrain upsizing of the extrusion device 5.

Further, by sending the high-pressure air, the gap between the inner peripheral surface 41a of the resin hollow body 40 and the outer peripheral surface 23a of the core portion 23 further expands, so that the resin hollow body 40 can be more smoothly removed from the core portion 23.

In a case where a hydrogen tank or the like is manufactured by use of the resin pipe 50 molded as such, it is possible to increase a storage amount of hydrogen as compared to a case where a resin pipe having a die-removal taper is used.

### Modification 1

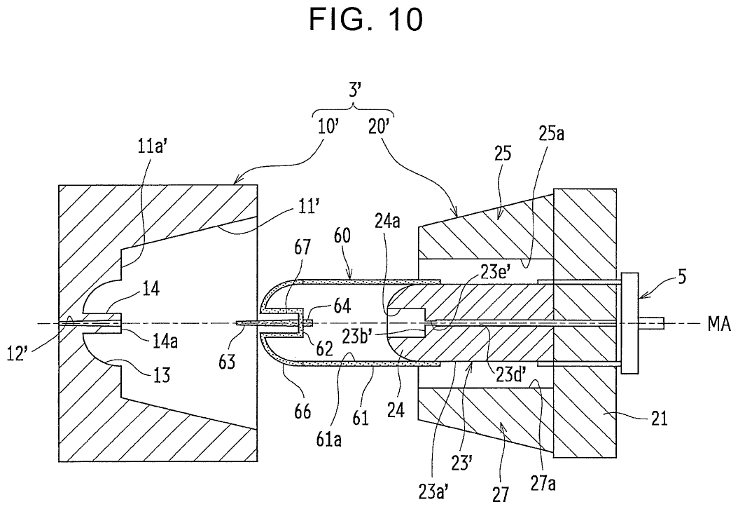

The present modification is different from the above embodiment in that a generally hemispherical dome portion 66 is formed in a front end portion of the resin hollow body 60 in the die-removal direction, as illustrated in FIG. 10. The following mainly describes points different from the above embodiment.

A resin hollow body 60 includes a cylindrical portion (a straight tubular portion) 61, the generally hemispherical dome portion 66 formed in an end portion of the cylindrical portion 61 on the second side in the axial direction, a cylindrical mouthpiece attachment portion 67 formed so as to penetrate through the dome portion 66 in the axial direction, and a closing portion 62 configured to close an end portion of the mouthpiece attachment portion 67 on the first side in the axial direction. A protrusion portion (not shown) similar to the protrusion portion 45 is formed in an end portion of the cylindrical portion 61 on the first side in the axial direction, and therefore, the cylindrical portion 61 is molded as an elongated straight tubular portion having an inner peripheral surface 61a that does not have a die-removal taper. Note that a reference sign 63 in FIG. 10 is a spool formed when the molten resin is cooled to solidify in a resin inlet 12′, and a reference sign 64 is a spool formed when the molten resin is cooled to solidify in a reduced portion 23e′.

The resin hollow body 60 is molded by use of an injection molding die 3′ including a fixed die 10′ and a movable die 20′. Similarly to the fixed die 10, a recessed portion 11′ is formed in the fixed die 10′, and in addition to this, a spherical recessed portion 13 is formed such that a bottom face 11a′ of the recessed portion 11′ is recessed in a generally hemispherical shape, and a protruding portion 14 having a generally pillar shape is formed so as to extend toward the first side in the axial direction inside the spherical recessed portion 13. Note that the resin inlet 12′ penetrates through the protruding portion 14.

In the meantime, a movable die 20′ includes the base portion 21 and the outer core portions 25, 27 similar to those in the movable die 20, but the shape of a core portion 23′ is different from that in the movable die 20. The core portion 23′ is different from the core portion 23 in that the core portion 23′ includes a spherical distal end portion 24 having a generally hemispherical shape in an end portion thereof on the second side in the axial direction. A hole portion 24a having a round section and extending in the axial direction is formed in the spherical distal end portion 24.

By use of such an injection molding die 3′, the cylindrical portion 61 is formed between the inner peripheral surfaces 25a, 27a of the outer core portions 25, 27 and an outer peripheral surface 23a′ of the core portion 23′, the dome portion 66 is formed between the spherical recessed portion 13 and the spherical distal end portion 24, the mouthpiece attachment portion 67 is formed between the protruding portion 14 and the hole portion 24a, and the closing portion 62 is formed between a distal surface 14a of the protruding portion 14 and an end surface 23b′ of the core portion 23′ on the second side in the axial direction.

Then, similarly to the above embodiment, a protrusion portion of the resin hollow body 60 is extruded from a groove (not shown) of the core portion 23′ by use of the extrusion device 5, and the closing portion 62 is pressed forward in the die-removal direction by high-pressure air from an air passage 23d′, so that the resin hollow body 60 is removed from the core portion 23′. After that, the spools 63, 64, the closing portion 62, and the protrusion portion are cut, so that a straight pipe having an end portion provided with the dome portion 66 can be obtained.

As described above, in the present modification, by devising the shapes of the fixed die 10′ and the core portion 23′, the resin hollow body 60 including the elongated cylindrical portion 61 having the inner peripheral surface 61a that does not have a die-removal taper and the dome portion 66 provided in the end portion of the cylindrical portion 61 can be easily molded.

### Modification 2

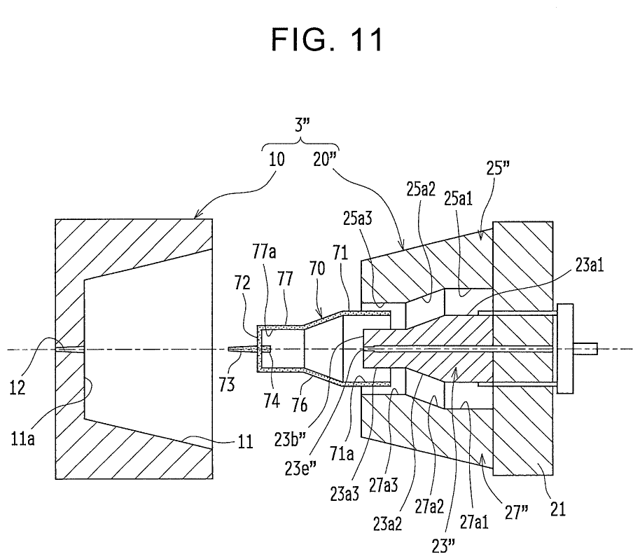

The present modification is different from the above embodiment in that the diameter of a resin hollow body 70 changes in the axial direction as illustrated in FIG. 11. The following mainly describes points different from the above embodiment.

The resin hollow body 70 includes a large-diameter cylindrical portion (a straight tubular portion) 71, a small-diameter cylindrical portion (a straight tubular portion) 77, an inclined tubular portion 76 connecting the large-diameter cylindrical portion 71 to the small-diameter cylindrical portion 77, and a closing portion 72 configured to close an end portion of the small-diameter cylindrical portion 77 on the second side in the axial direction. A protrusion portion (not shown) similar to the protrusion portion 45 is formed in an end portion of the large-diameter cylindrical portion 71 on the first side in the axial direction, and therefore, the large-diameter cylindrical portion 71 and the small-diameter cylindrical portion 77 are molded as elongated straight tubular portions having inner peripheral surfaces 71a, 77a that do not have a die-removal taper. Note that a reference sign 73 in FIG. 11 is a spool formed when the molten resin is cooled to solidify in the resin inlet 12, and a reference sign 74 is a spool formed when the molten resin is cooled to solidify in a reduced portion 23e″.

The resin hollow body 70 is molded by use of an injection molding die 3″ including the fixed die 10 and a movable die 20″. The movable die 20″ includes the base portion 21 similar to that in the movable die 20, but the shapes of outer core portions 25″, 27″ and a core portion 23″ are different from those in the movable die 20. The outer core portions 25″, 27″ are different from the outer core portions 25, 27 in that the outer core portions 25″, 27″ respectively include large-diameter inner peripheral surfaces 25a1, 27a1 having the same diameter as the inner peripheral surfaces 25a, 27a, small-diameter inner peripheral surfaces 25a3, 27a3 smaller in diameter than the inner peripheral surfaces 25a, 27a, and inclined inner peripheral surfaces 25a2, 27a2 connecting them to each other.

The core portion 23″ is different from the core portion 23 in that the core portion 23″ includes a large-diameter outer peripheral surface 23a1 having the same diameter as the outer peripheral surface 23a, a small-diameter outer peripheral surface 23a3 smaller in diameter than the outer peripheral surface 23a, and an inclined outer peripheral surface 23a2 connecting them to each other.

By use of such an injection molding die 3″, the large-diameter cylindrical portion 71 is formed between the large-diameter inner peripheral surfaces 25a1, 27a1 of the outer core portions 25″, 27″ and the outer peripheral surface 23a1 of the core portion 23″, the inclined tubular portion 76 is formed between the inclined inner peripheral surfaces 25a2, 27a2 and the inclined outer peripheral surface 23a2, the small-diameter cylindrical portion 77 is formed between the small-diameter inner peripheral surfaces 25a3, 27a3 and the small-diameter outer peripheral surface 23a3, and the closing portion 72 is formed between the bottom face 11a of the fixed die 10 and an end surface 23b″ of the core portion 23″ on the second side in the axial direction.

As described above, in the present modification, by devising the shapes of the outer core portions 25″, 27″ and the core portion 23″, the resin hollow body 70 including the elongated large-diameter cylindrical portion 71 and the small-diameter cylindrical portion 77 that do not have a die-removal taper, that is, the resin hollow body 70 changing in diameter in the axial direction can be easily molded.

### Modification 3

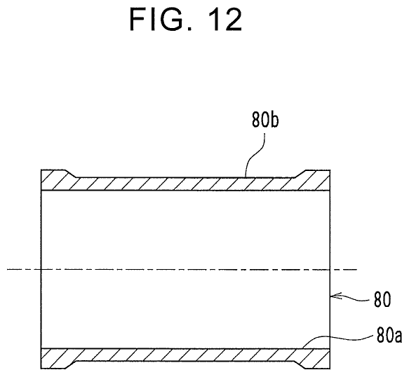

The present modification is different from the embodiment in that the sectional shape of an outer peripheral surface 80b of a resin pipe 80 changes as illustrated in FIG. 12.

For example, in extrusion molding, a straight pipe can be easily molded, but it is difficult to mold a pipe changing in plate thickness.

On the other hand, in the present modification, by a technique similar to the above embodiment, it is possible to mold the elongated resin pipe 80 having an inner peripheral surface 80a that does not have a die-removal taper, similarly to the extrusion molding. In addition to this, by devising the shapes of the inner peripheral surfaces 25a, 27a of the outer core portions 25, 27 as split dies, the resin pipe 80 in which the sectional shape of the outer peripheral surface 80b changes, that is, the resin pipe 80 changing in plate thickness in the axial direction can be easily molded, as illustrated in FIG. 12.

### Other Embodiments

The disclosure is not limited to the above embodiment and can be carried out in other various forms without departing from the spirit or main feature of the disclosure.

The above embodiment exemplifies a hydrogen tank as a purpose of the resin pipe 50, but the disclosure is not limited to this, and the resin pipe 50 can be applied to various purposes.

Further, in Modification 2, the large-diameter cylindrical portion 71 is connected to the small-diameter cylindrical portion 77 via the inclined tubular portion 76. However, the disclosure is not limited to this, and the large-diameter cylindrical portion 71 may be connected to the small-diameter cylindrical portion 77 via a toric stepped surface, for example.

Thus, the above embodiment is just an example in every respect and must not be interpreted restrictively. Further, modifications and alterations belonging to an equivalent range of Claims are all included in the disclosure.

With the disclosure, it is possible to accurately mold a resin hollow body including an elongated straight tubular portion having an inner peripheral surface that does not have a die-removal taper with a simple configuration while damages caused due to demolding are reduced. Accordingly, the disclosure is extremely useful when the disclosure is applied to an injection molding die, an injection molding system, and an injection molding method each for molding a resin hollow body.

What is clamed is:

1. An injection molding die for molding a resin hollow body including a straight tubular portion having an inner peripheral surface that does not have a tapered portion for die removal, the injection molding die comprising a core including a cylindrical portion configured to form the inner peripheral surface of the straight tubular portion, wherein a groove recessed inwardly in a radial direction is formed over a whole circumference of the cylindrical portion in an end portion of the core on a first side in an axial direction, the end portion corresponding to a rear end portion of the resin hollow body in a die-removal direction.

2. The injection molding die according to claim 1, further comprising an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction, wherein the core includes an air passage penetrating through the core in the axial direction.

3. An injection molding system for molding a resin hollow body including a straight tubular portion having an inner peripheral surface that does not have a tapered portion for die removal, the injection molding system comprising:
an injection molding die including
a core including a cylindrical portion configured to form the inner peripheral surface of the straight tubular portion, the core having a groove recessed inwardly in a radial direction and formed over a whole circumference of the cylindrical portion in an end portion of the core on a first side in an axial direction, the core including an air passage penetrating through the core in the axial direction, and
an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction;
an extrusion device configured to press an end portion of the resin hollow body on the first side in the axial direction toward the second side in the axial direction, the resin hollow body being formed on an outer periphery of the core; and
a high-pressure air supply device configured to send high-pressure air into the air passage.

4. An injection molding method for molding a resin hollow body including a straight tubular portion having an inner peripheral surface that does not have a tapered portion for die removal, the injection molding method comprising:
preparing an injection molding die including
a core including a cylindrical portion configured to form the inner peripheral surface of the straight tubular portion, the core having a groove recessed inwardly in a radial direction and formed over a whole circumference of the cylindrical portion in an end portion of the core on a first side in an axial direction, the core including an air passage penetrating through the core in the axial direction, and
an outer die placed such that cavities are formed between the outer die and an end surface of the core on a second side in the axial direction and between the outer die and an outer peripheral surface of the core, the outer die being displaceable to separate from the core toward the second side in the axial direction and toward an outer side in the radial direction;
filling molten resin into the cavities formed between the outer die and the end surface of the core on the second side in the axial direction and between the outer die and the outer peripheral surface of the core;
displacing the outer die toward the second side in the axial direction and toward the outer side in the radial direction relative to the core;
pressing the resin hollow body toward the second side in the axial direction, such that a protrusion portion formed inside the groove so as to project inwardly in the radial direction runs onto the outer peripheral surface of the core; and
sending high-pressure air into the air passage so as to extrude the resin hollow body toward the second side in the axial direction.
